(19) United States
(12) Patent Application Publication
(10) Pub. No.: US 2007/0266135 A1
(43) Pub. Date: Nov. 15, 2007

(54) Multiple active session management interface

(76) Inventors: Liam Friedland, Redwood City, CA (US); Peer Hilgers, St. Leon-Rot (DE)

Correspondence Address: KENYON & KENYON LLP, ONE BROADWAY, NEW YORK, NY, 10004, US

(21) Appl. No.: 11/435,197

(22) Filed: May 15, 2006

(51) Int. Cl. G06F 15/173; G06F 3/00

(52) U.S. Cl. 709/223; 715/733

(57) ABSTRACT

A user interface allows for managing multiple active computing sessions. The interface displays a primary active session in a primary display and indicators for each of a plurality of secondary active sessions, which include sessions computationally active in the underlying processing environment but not actively engaged to the user through the interface. Upon receipt of an end-session notice for one of the secondary active sessions, the interface displays an end-session notification. The end-session notice includes information as to an expiration condition causing the prospective termination of the session. The interface thereupon actively displays end-session notification in a tertiary display relative to the indicator of the corresponding active session in the secondary display. The notification includes one or more active link action commands allowing a user to select an activity within the tertiary display to thereupon manage the secondary active session without interrupting the primary active session.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relates generally to an interface and more specifically to an interface and the underlying processing techniques for managing multiple active sessions of one or more software applications through a central interface.

In multiple application execution environments, it can be problematic to manage various active sessions. There are known interfaces for providing display of multiple active sessions, where an active session is an application or other routine that is executed and operating on a processing system. An active session may be a local or remote application. For example, a local application may be a desktop based application in a personal computing environment. A networked application may include one or more components of the application engaging computing resources remote to the local processing device.

One example of an active session in a remote processing environment includes a local application executable on a local processing environment engaging a back-end operating system. An example of this type of active session may be accessing a back-end database where a front end interface provides a graphical interface for using the application, but the data is accessed remotely. It is also recognized that various levels of computations may be done locally and the active session intermittently or periodically interfaces with a back end system, such as a back end database. In other options, the application itself may be executed on a remote server and the local computing device interfaces the data operations from the server, facilitating local-based user interaction to the back-end processing system.

When a processing system or interface includes numerous active applications, it can be problematic to actively manage these different sessions. For example in a Macintosh-based environment, a display of icons is visible in a central location, called a dock. To illustrate that one or more applications are active, the dashboard includes an arrow or other type of indicator. Similarly, Windows-based environments provide bars including icons of the active applications in a designated location, such across the base of the screen.

While managing these applications from an interface perspective includes notifying a user of which applications are engaged, these techniques can be problematic when addressing concerns with active sessions, where the active sessions may include engagement of a back end application. Some back-end applications include restrictions on remote access. For example, if an active session is directed to accessing a secure database, the active session may include a time-out feature based on periods of inactivity or system efficiency.

Existing systems fail to actively manage these active sessions and do not provide users effective information regarding time-out issues. For example, in the Macintosh user interface system, the dashboard provides visual queue of the icon appearing to bounce when the application requires the user's attention. This technique fails to identify the reasons why the application or active session requires the user's attention, and thus in a time-out condition could accidentally time-out the active session without the user's knowledge.

Another technique previously used included an interrupt technique. When an application required immediate attention, the interface application may interrupt the presently active application with a pop-up window or other obtrusive notification. This technique may include a message as to why the interrupt occurs, but is an obtrusive technique overriding engagement of the active application for the interrupt. Therefore, even if a user desired to ignore the message, this technique requires diverting attention to the active window.

This technique further included text directing a user to the active session requesting attention. For example, if the active session requesting attention was a dial-in or other login feature to an Internet service provider, the pop-up window directed the user to the active session only. Once inside the active session, the user would then be additionally required to manually effectuate further activities, such as requesting to keep a dormant session active. Therefore, these time-out features failed to properly notify the user of time-out concerns and allow a user to manage the various active sessions without interrupting current operations.

### BRIEF DESCRIPTION OF THE DRAWINGS

FIG. 1 illustrates a processing environment having a user interface in accordance with one embodiment of the present invention;

FIG. 2 illustrates a block diagram of one embodiment of a processing system operative to provide the user interface in accordance with one embodiment of the present invention;

FIG. 3 illustrates a graphical representation of a sample screen shot of the user interface in accordance with one embodiment of the present invention;

FIG. 4 illustrates a schematic diagram of one embodiment of an apparatus for providing a visual display of a plurality of active sessions in an interface; and

FIG. 5 illustrates a flowchart of the steps of one embodiment of a method for managing multiple active sessions in an interface.

### DETAILED DESCRIPTION

Active management of multiple active computing sessions with a single interface allows a user to perform multiple tasks on a single platform. Although, when having active computing sessions, which include launched applications which may include access to back-end processing systems, it can be complicated to manage time-sensitive concerns for the various sessions. For example, different active sessions may include time-limited access to the back-end system, which expires after a predefined period of inactivity. With the interface allowing the active management of these sessions, the interface further includes visual notification as well as active links for resolving any expiration concerns for active sessions.

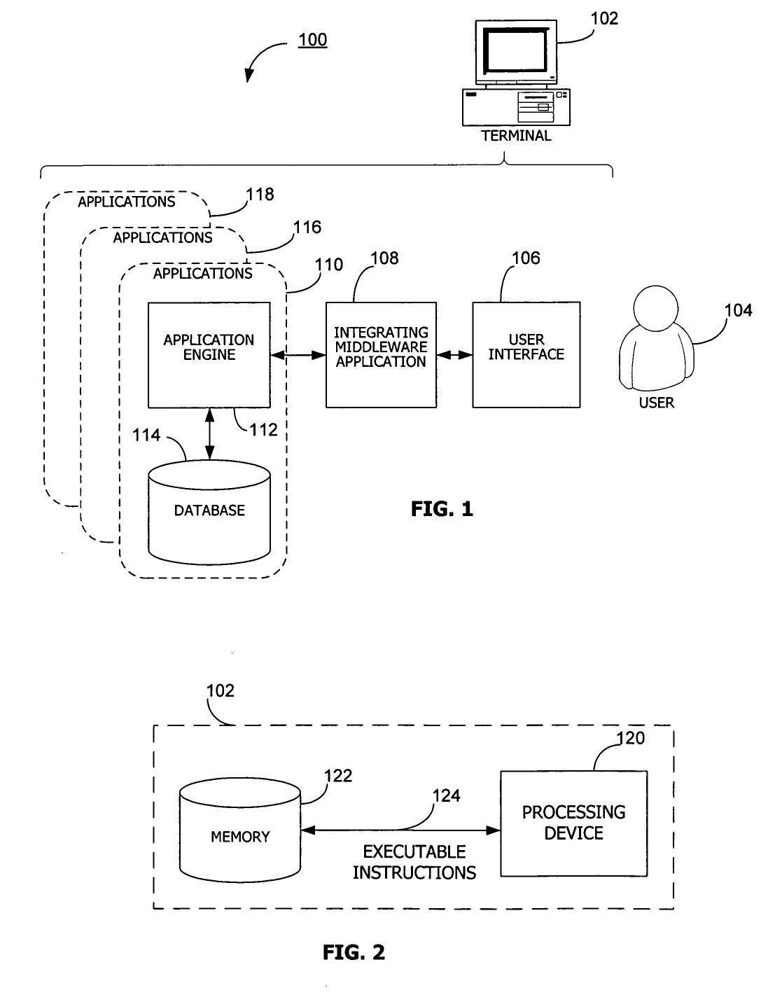

FIG. 1 illustrates a system 100 for providing a transaction browser that includes an interface according to an embodiment of the present invention. A terminal 102 may be available to a user 104. The terminal 102 may include an output device such as a display screen and an input device such as a keyboard or a mouse. For example, the terminal 102 may be a personal computer, a laptop computer, a tablet computer, a personal digital assistant (PDA) or a wireless device such as a cell phone.

The terminal 102 may include a processor configured to execute various application programs such as browser programs, word processing programs, spreadsheet programs, enterprise management applications and other applications. For example, the terminal 102 may execute a user interface 106. For example, the user interface 106 may be implemented as a shell program.

The user interface 106 may be in communication with an integrating middleware application 108. The middleware application 108 may interface between the user interface 106 and applications 110. Applications 110 may include an application engine 112 and a database 114. More than one application engine may be provided, but only one is depicted. For example, each application engine may execute a plurality of applications.

The application engine 112 may execute different applications, such as a calendar software, a contacts management software, a customer data entry form, sales order creation form, or other applications. The database 114 may include data relevant to the applications offered on the terminal 102. Data may include information for each transaction or report available through the applications 110. Data may also include business logic defining available actions in applications 110.

The terminal 102 may include a plurality of applications. For example, Applications 116 and 118 may also execute on the terminal 102. Each of Applications 116 and 118 may be similar to Applications 110, including an application engine and a database.

The terminal 102 may include a network interface configured to communicate with a server. For example, the applications 110 may be located at the server. In this example embodiment, the middleware application 108 may communicate with the applications 110, 116 and/or 118 via the network interface.

FIG. 2 illustrates a representative embodiment of hardware components within the terminal 102, including a processing device 120 and a memory 122. The processing device 120 may be one or more processing elements operative to perform processing operations in response to executable instructions 124 stored in and received from the memory 122. The memory 122 may be one or more memory devices capable of storing the executable instructions for retrieval and usage by the processing device 120. The processing device 120, in response to the executable instructions 124 is operative to provide the interface 106 and perform various operations as described in further detail below.

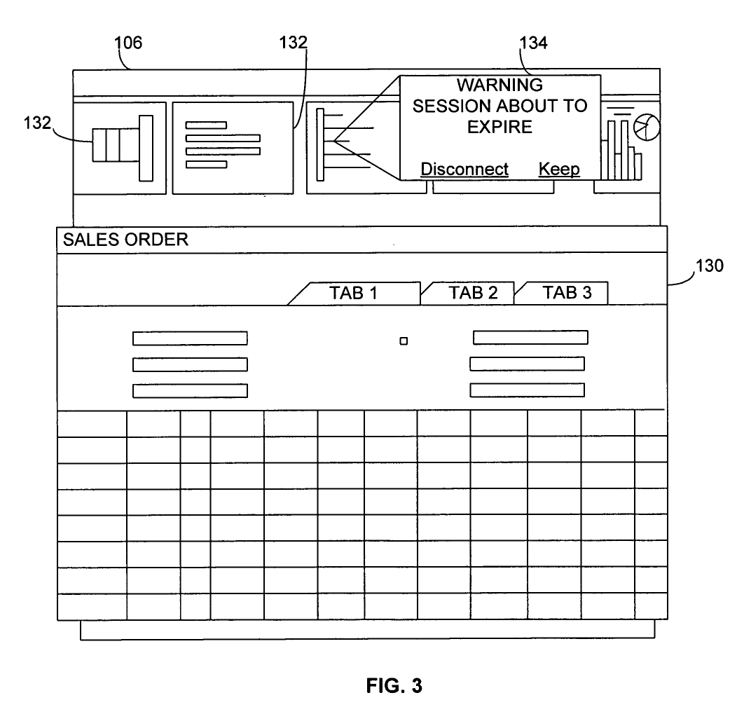

FIG. 3 illustrates a graphical representation of a screen shot 130 of the user interface 106. The user interface includes a primary session display 130, a secondary session display 132 and a tertiary display 134. The primary session display 130 provides a display of an active primary session, which in this sample screen shot is a sales order form. The active session represents a visual display of the primary active session, so designated based on its foreground positioning and thereby active engagement by the user. The active session provides normal input/output functionality for a user running the application, regardless of the underlying processing operations, such as the applications 110, 116 or 118 of FIG. 1.

The secondary session display 132 provides a visual indication of an application or other type of session, which is active to the terminal 102, but not active to a display. From a processing perspective this, the secondary active sessions are maintained in an active state as user interface operations may allow the user to change the primary session display 130 between the various sessions. For example, in the interface 106, the secondary displays 132 may be active buttons or tabs such that upon selection of one of these buttons or tabs, the interface 106 may exchange the primary session. In one embodiment, the indicators of the secondary display 132 may include a thumbnail or other type of image of the appearance of the secondary active session.

The tertiary display 134 of FIG. 3 may be a pop-up window or similar type of display providing a visual overlay over indicators in the secondary display 132. In the operation of the interface 106, the interface 106 provides this tertiary display 134 in response to an end-session notice received from a corresponding back end processing system or application accessing the system, such as accessing the middleware application 108 of FIG. 1. Visible within the tertiary display 134 of FIG. 3, the interface 106 generates an end-session notice that indicates an expiration condition for the corresponding active session.

Additionally, the tertiary display 134 includes one or more action commands disposed therein, where the action commands include active links to corresponding operations or instructions for the application or system the generates the end-session notice. For example, if the end-session notice is generated because the system the application or access to a back-end system has been idle, an active link command may be an instruction to “disconnect” or to maintain or “keep” the connection. The selection of these active commands in the interface provides a corresponding functionality to the application itself without disrupting the primary active session in display 130.

It is also recognized that the tertiary display 134 may include additional information to facilitate the management of multiple active computing sessions. For example, the end-session notice may include meta data or other informational data usable for further information in the tertiary display 134, such as timing information indicating a countdown or other visual illustration of a time until the active session expires.

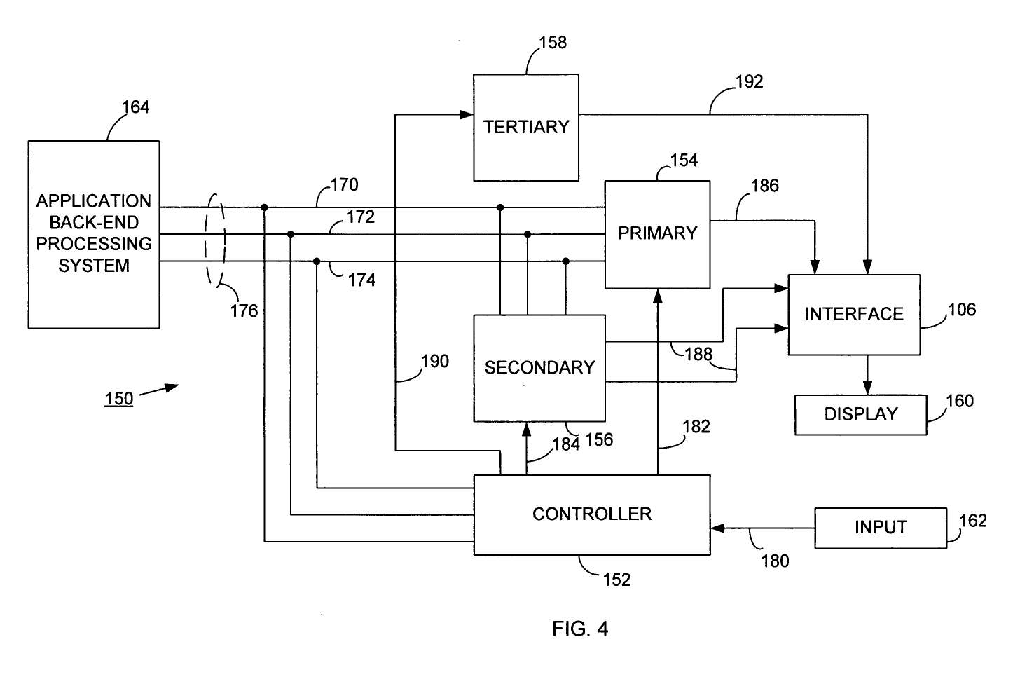

FIG. 4 illustrates a block diagram of one embodiment of functionality behind the interface 106. The device for managing multiple active computing sessions in the interface 106 includes a controller 152, a primary display generator 154, a secondary display generator 156, a tertiary display generator 158, a display device 160 coupled to the interface 106, an input device 162 and communication with an application/back-end processing system 164.

The controller 152 and generators 154, 156 and 158 may be implemented in hardware, software or a combination thereof for performing operations as described herein. The display 160 may be the display associated with the terminal 102 of FIG. 1 as well as the input device 162 may be any suitable input device usable with the terminal 102 of FIG. 1. The application/back-end processing system 164 may be applications 110, 116 or 118 of FIG. 1 or may also include back-end processing systems such as remote access servers, databases or other computing environments accessible through the interface or middleware application (not shown).

As illustrated in FIG. 4, the application/back-end processing system 164 provides numerous active connections 170, 172 and 174 across a connection 176, which may be an internally hardwired connection, such as within the terminal 102 of FIG. 1 or may be a networked connection to one or more remote systems. It is also recognized that application/back-end processing system 164 provides three connections, but the device 150 can accommodate any suitable number of connections indicating various active sessions viewable on the interface 106.

In this visual representation, the controller 152 receives display instructions as to which active session is to be a primary active session and which sessions are to be designated as secondary active sessions. In response to an input 180, the controller provides a primary command 182 to the primary display generator 154 and a secondary command 184 to the secondary command generator 156.

While having the ability to actively display any one of the active sessions, the primary display generator 154 enables a selected primary display, providing a primary display signal 186 to the interface 106. Similarly, secondary display generator 156 provides the proper number of secondary display signals 188 to the interface 106. The primary display signal 186 may the full interactive session designated by the user in the primary display and the secondary display signals may be the indicators, such as the indicators in the second display 132 of FIG. 3.

In FIG. 4, the controller 152 is also in communication with the active connections 170, 172 and 174. It is across these active connections that the application/back-end processing system 164 may provide the end-session notification. This end-session notification includes information usable for notifying the user through the interface 106, such as terms for the expiration of the active session, such as indicating a period of inactivity or maybe too large of a processing load on the application/back-end system 164.

The controller 152 thereupon generates an end-session notice command 190, which may be a processing instruction that includes information regarding the notification. The tertiary display generator 158 receives the end-session notice command 190, which is operative to generate an end-session notice 192 for one of the secondary active sessions. This notice 192 is provided to the interface 106 for display on the display device 160.

Such as illustrated in the screen shot of FIG. 3, the end-session notice command provides a visual display, through the interface 106, of the tertiary display 134 including the end-session notice. The notice includes the active commands. Therefore, in a course of operation, the user may be interacting with the application in the primary display, while also being presented with a visual display of indicators for the secondary active sessions. Upon receipt of an end-session notification, for example based on a time-out function that one of the secondary applications was not accessed for a defined period of time, the user maintains active interaction with the primary display, but is also presented with the non-obtrusive display of the tertiary display relative to a corresponding secondary display. Additionally, the non-obtrusive tertiary display includes not only information regarding the condition that brought about the notification, but also active links or commands for resolving this concern. This three level display and interactivity is available through the interface 106, based on the display generators 154, 156 and 158.

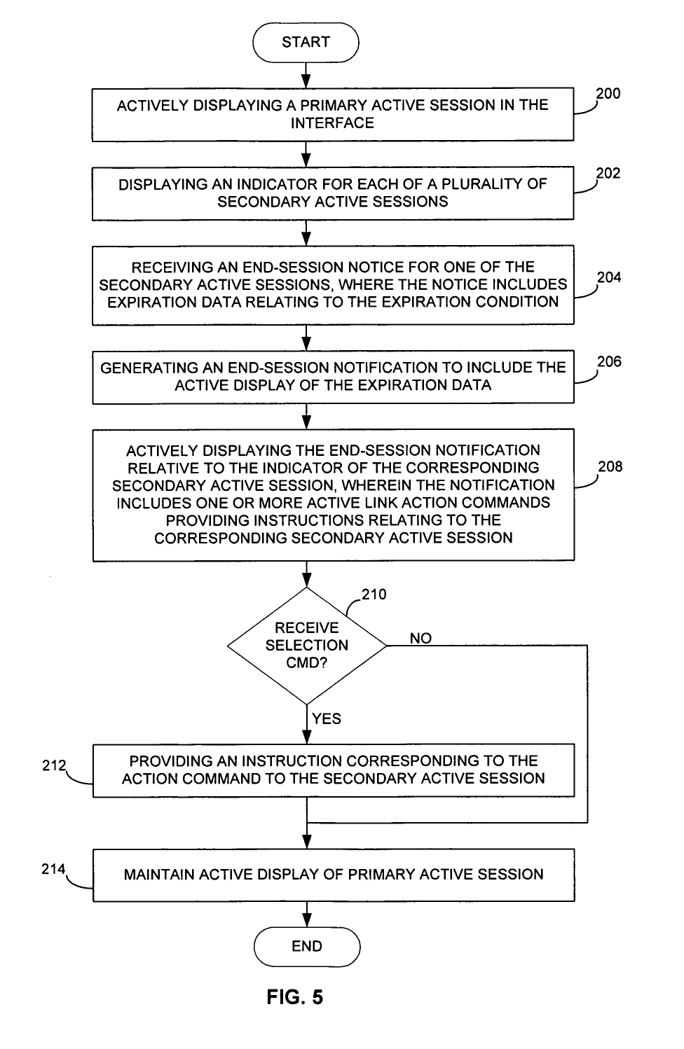

FIG. 5 illustrates the steps of a flowchart of one embodiment of a method for managing multiple active computing sessions in an interface. It is recognized that the steps of this method may be performed, in response to executable instructions, by the processing device 120 of FIG. 2 as may be disposed in the terminal 102 of FIG. 1.

In this embodiment, a first step, step 200, is actively displaying a primary active session in the interface. As illustrated in the screen shot of FIG. 3, the primary active session is visible in the primary display 130 of the interface 106. The next step, step 202, is displaying an indicator for each of a plurality of secondary active sessions. Referring again to the screen shot of FIG. 3, the secondary display 132 includes indicators for each of the plurality of secondary active sessions.

The next step, step 204, is receiving an end-session notice for one of the secondary active sessions, where the notice includes expiration data relating to an expiration condition. This notification may be generated by the application or back-end processing system to indicate that the session itself, whether it is the application or connection to a back-end server, database or other access point is to be terminated. The next step, step 206, is generating an end-session notification to include the active display of the expiration data.

The end-session notification may be a data encoded instruction command usable by the interface for providing the active display of the end session notification, step 208. The end-session notification may include various components of information for the user, including active links to corresponding functionalities and information about factors relating to why the notification arose. For example, active display of the end-session notification may include the display of a clock providing a visual indication of a countdown until the session expires. The active display of the end-session notification is also provided relative to the corresponding secondary session to which the notification relates, as illustrated in the screen shot of FIG. 3.

The next step, step 210 is a determination if a selection command has been received. In the embodiment of FIG. 4, the controller 152 in response to an input from the input device 162 may make the determination. For example, in a graphical user interface environment, the input may be selection via a mouse click or hot key depression.

If an input directed to a selection command is received, the next step, step 210, is providing an instruction corresponding to the action command to the secondary active session. Referring back to FIG. 4, the controller 152 may then utilize the communication with the application/back-end processing system 164 to effectuate the command. For example, if the action command is to maintain the active session, the controller 152 may provide an instruction to application/back-end processing system 164 to reset a time-out or inactivity monitor. Or in another example, the instruction may be to terminate the session, therefore the controller 152 may provide the instruction to save the data and thus either terminate or allow the session to expire.

In the event a selection command is not received, in step 210, or whether a command is received, the method further includes the step of maintaining the active display of the primary active session, step 212. This, thereupon, provides the user interface allowing for the management of active sessions through the secondary display and the inclusion of the notification in the tertiary display relative without interfering with the primary display. Therefore, in this embodiment, the method is complete.

Therefore, through the utilization of a primary display, a secondary display and a tertiary display, the user interface provides for the management of multiple active sessions. The receipt of the end-session notice allows for the end-session notification to be unobtrusively displayed in the tertiary display, relative to the corresponding session indicator in the secondary display. Through this notification and the active links embedded therein, the interface allows for the maintenance of the primary active session and the primary display and the management of the secondary active sessions in the secondary display.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A method for managing multiple active computing sessions in an interface, the method comprising:
actively displaying a primary active session in the interface;
displaying an indicator for each of a plurality of secondary active sessions;
receiving an end-session notice for one of the secondary active session indicating an expiration condition for the corresponding secondary active session; and
actively displaying an end-session notification based on the end-session notice, the notification displayed relative to the indicator of the corresponding secondary active session, wherein the notification includes at least one active link action command relating to instructions for the corresponding secondary active session.

2. The method of claim 1 wherein the end-session notice includes expiration data relating to the expiration condition, the method further comprising:
generating the end-session notification to include the active display of the expiration data relating to the expiration condition.

3. The method of claim 2 wherein the expiration data includes an active clock indicating a time-based countdown until the secondary active session is terminated.

4. The method of claim 1 wherein the multiple active computing sessions relate to back-end processing systems accessible through the interface.

5. The method of claim 1, the method further comprising:
receiving a selection command for one of the action commands; and
providing an instruction corresponding to the action command to the secondary active session.

6. The method of claim 5 further comprising:
receiving the selection command and providing the instruction to the secondary active session without adjusting the display of the primary active session.

7. The method of claim 1 wherein the indicator includes a thumbnail image of the appearance of the secondary active session.

8. An interface for managing multiple active computing sessions comprising:
a primary session display displaying a primary active session;
a secondary display displaying indicators for each of a plurality of secondary active sessions;
upon receipt of an end-session notice for one of the secondary active sessions, where the end-session notice indicates an expiration condition for the corresponding secondary active session, a tertiary display relative to the secondary display displaying an end-session notification based on the end-session notice; and
at least one action command disposed within the tertiary display relating to instructions for the corresponding secondary active session.

9. The interface of claim 8 wherein the end-session notice includes expiration data relating to the expiration condition, the interface further comprising:
the tertiary display includes the active display of the expiration data with the end-session notification.

10. The interface of claim 9 wherein the tertiary display further includes the display of an active clock indicating a time-based countdown until the secondary active session is terminated based on the expiration data.

11. The interface of claim 8 wherein the primary active session and the secondary active sessions are executed on back-end processing systems accessible and viewable through the interface.

12. The interface of claim 8 wherein the interface is operative to receive a selection command for one of the action commands and providing an instruction corresponding to the action command to the secondary active session without adjusting the display of the primary active session.

13. The interface of claim 8 wherein the indicator includes a thumbnail image of the appearance of the secondary active session.

14. An apparatus for managing multiple active computing session in an interface on a display device, the apparatus comprising:
a memory device storing executable instructions; and
a processing device providing an output display to the display device operative to, in response to the executable instructions:
actively display a primary active session in the interface;
display an indicator for each of a plurality of secondary active sessions;
receive an end-session notice for one of the secondary active session indicating an expiration condition for the corresponding secondary active session; and
actively display an end-session notification based on the end-session notice, the notification displayed relative to the indicator of the corresponding secondary active session, wherein the notification includes at least one active link action command relating to instructions for the corresponding secondary active session.

15. The apparatus of claim 14 wherein the end-session notice received by the processing device includes expiration data relating to the expiration condition, the processing device is further operative to:
generate the end-session notification to include the active display of the expiration data relating to the expiration condition.

16. The apparatus of claim 15 wherein the expiration data includes an active clock indicating a time-based countdown until the secondary active session is terminated.

17. The apparatus of claim 14, the processing device, in response to executable instructions, further operative to:
communicate with at least one back-end processing device executing back-end processing functionality associated with the active sessions being accessible through the interface.

18. The apparatus of claim 14, the processing device, in response to executable instructions, further operative to:
receive a selection command for one of the action commands; and
provide an instruction corresponding to the action command to the secondary active session without adjusting the display of the primary active session.

19. The apparatus of claim 14 wherein the indicator displayed on the display device includes a thumbnail image of the appearance of the secondary active session.

20. An apparatus for providing a visual display of a plurality of active sessions on a display device, the apparatus comprising:
an interface operative to provide a graphical output to a display device;
a primary display generator providing a primary display of one of the active session through the interface;
a second display generator providing at least one secondary display of the active sessions through the interface;
a controller coupled to receive input commands from an input device and coupled to the primary display generator and the secondary display generator; and
a tertiary display generator operative to generate an end-session notice for one of the secondary active session indicating an expiration condition for the corresponding secondary active session in response to an end-session notice command received from the controller, wherein the controller generates the end-session notice command in response to an end-session notification received from the back-end processing system; and
the interface operative to actively display the notification relative to the indicator of the corresponding secondary active session, wherein the notification includes at least one active link action command relating to instructions for the corresponding secondary active session.

21. The apparatus of claim 20 wherein the end-session notification includes expiration data relating to the expiration condition, the tertiary display providing the end-session notification to the interface, the notification including the active display of the expiration data relating to the expiration condition.

22. The apparatus of claim 20 wherein the controller, upon receipt of input commands, provides the input command to the back-end processing system as corresponding to an input to the active session in the primary display.

23. The apparatus of claim 20 wherein the secondary display includes a thumbnail for each of the corresponding active sessions.

24. The apparatus of claim 20 wherein the back-end processing system is accessible across a network.
